(19) United States
(12) Patent Application Publication
(10) Pub. No.: US 2010/0166259 A1
(43) Pub. Date: Jul. 1, 2010

(54) OBJECT ENUMERATING APPARATUS AND OBJECT ENUMERATING METHOD

(76) Inventors: Nobuyuki Otsu, Ibaraki (JP); Yasuyuki Shimohata, Tokyo (JP)

Correspondence Address: NIXON & VANDERHYE, PC, 901 NORTH GLEBE ROAD, 11TH FLOOR, ARLINGTON, VA, 22203, US

(21) Appl. No.: 12/377,734

(22) PCT Filed: Aug. 15, 2007
(86) PCT No.: PCT/JP2007/065899

§ 371 Date: Feb. 17, 2009

(30) Foreign Application Priority Data
Aug. 17, 2006 (JP) 2006-222462

(51) Int. Cl. G06K 9/00

(52) U.S. Cl. 382/103; 382/154; 382/190

(57) ABSTRACT

An object enumerating apparatus comprises means for generating and binarizing inter-frame differential data from moving image data representative of a photographed object under detection, means for extracting feature data from a plurality of the inter-frame binary differential data directly adjacent to each other on a pixel-by-pixel basis through cubic higher-order local auto-correlation, means for calculating a coefficient of each factor vector from a factor matrix comprised of a plurality of factor vectors previously generated through learning using a factor analysis and arranged for one object under detection, and the feature data, and means for adding a plurality of the coefficients for one object under detection, and rounding off the sum to the decimal point to the closest integer representative of a quantity. By courtesy of small fluctuations in the sum of coefficients and accurate matching with the quantity of objects intended for recognition, a recognition can be accomplished with robustness to differences in scale and speed of objects and to dynamic changes thereof.

### TECHNICAL FIELD

The present invention relates to an object enumerating apparatus and an object enumerating method which are capable of capturing a moving image to separately detect the quantities of a plurality of types of objects, such as persons, cars and the like which move in arbitrary directions, on a type-by-type basis.

### BACKGROUND ART

At present, the recognition of moving objects is an important challenge in a monitoring camera system, an advanced road traffic system, a visual sense of robots, and the like. Also, the manner in which persons flow and are crowded can be monitored and recorded from one minute to the next for purposes of obviating accidents which would occur if persons concentrate on a single location, providing free/busy information, for utilization in strategies such as a personnel assignment plan and the like within an establishment, so that a need exists for monitoring persons as to how they are flowing and how they are crowded.

For a system which automatically monitors how persons are flowing and how they are crowded, it is necessary to have the ability to robustly recognize at high speeds an overall situation such as the flow and quantity of moving objects. However, it is a quite difficult challenge for a computer to automatically recognize a moving object. Factors which make the recognition difficult may include, for example, the following ones:

(1) A plurality of persons, and a variety of types of moving objects such as bicycles exist within an image of a camera.

(2) Even the same moving object presents motions in various directions at various speeds.

(3) There are a variety of scales (sizes) of objects within a screen due to the distance between the camera and objects, the difference in height between adults and children, and the like.

While a large number of researches exist for detecting and recognizing moving objects, most of them mark out and track the moving objects, disadvantageously involving a calculation cost in proportion to the number and type of objects, and therefore experience difficulties in accurately recognizing a large number of objects at high speeds. Also, they suffer from a low accuracy of detection due to a difference in scale and the like.

On the other hand, the following Patent Document 1 filed by the present inventors discloses a technology for extracting higher-order local auto-correlation features for a still image, and estimating the quantity of objects using a multivariate analysis.

Patent Document 1: Japanese Patent No. 2834153.

The present inventors have also studied an abnormal action recognition for recognizing the difference in motion of an object from an entire image, and the following Patent Document 2 filed by the present inventors discloses a technology for recognizing abnormal actions using cubic higher-order local auto-correlation features (hereinafter called “CHLAC features” as well).

Patent Document 2: JP-2006-079272-A

When one wishes to know a general situation such as the quantity of moving objects and their flow, information on the position of individual objects is not required. What is important is to know a general situation such as one person walking to the right, two persons walking to the left, one bicycle running to the left, and so forth, and the manner in which persons are flowing and crowded can be sufficiently ascertained only with information on such a situation and changes thereof, even without tracking all moving objects involved therein.

In the abnormal action recognition technology described above, CHLAC features extracted from an entire moving image screen is used as action features, and the CHLAC features have a position invariant value independent of the location or time of an object. Also, when there are a plurality of objects within a screen, additivity prevails, where an overall feature value is the sum of respective individual feature values. Specifically, when there are two “persons walking to the right,” by way of example, the feature value is twice the feature value of one “person walking to the right.” Thus, it is envisioned that the CHLAC features can be applied to the detection of the quantity of moving objects and directions in which they move.

### DISCLOSURE OF THE INVENTION

### Problems to be Solved by the Invention

When an attempt is made to apply the aforementioned CHLAC features to the detection of the quantity and flow of moving objects, feature values vary depending on the scale (size) of the objects on a moving image screen and the type of movements (speed and direction), thus giving rise to a problem that the quantity is detected with lower accuracy.

It is an object of the present invention to provide an object enumerating apparatus and an object enumerating method which are capable of solving problems of the prior art examples as described above and capturing a moving image to accurately detect the quantities of a plurality of types of objects, on a type-by-type basis, such as persons, cars and the like which move in a predetermined direction, using cubic higher-order local auto-correlation features.

### Means for Solving the Problems

An object enumerating apparatus of the present invention is mainly characterized by comprising binarized differential data generating means for generating and binarizing inter-frame differential data from moving image data comprised of a plurality of image frame data representative of a photographed object under detection, feature data extracting means for extracting feature data from three-dimensional data comprised of a plurality of the inter-frame binary differential data directly adjacent to each other through cubic higher-order local auto-correlation, coefficient calculating means for calculating a coefficient of each factor vector from a factor matrix comprised of a plurality of factor vectors previously generated through learning and arranged for one object under detection, and the feature data, adding means for adding a plurality of the coefficients for one object under detection, and round-off means for rounding off an output value of the adding means to the decimal point to the closest integer representative of a quantity.

Also, the object enumerating apparatus described above is further characterized by comprising learning means for generating a factor matrix based on feature data derived from learning data. Also, the object enumerating apparatus described above is further characterized in that the learning means comprises binarized differential data generating means for generating and binarizing inter-frame differential data from moving image data comprised of a plurality of image frame data representative of a photographed object under detection which comprises learning data, feature data extracting means for extracting feature data from three-dimensional data comprised of a plurality of the inter-frame binarized differential data through cubic higher-order local auto-correlation, and factor matrix generating means for generating a factor matrix from the feature data corresponding to a plurality of learning data through a factor analysis using a known quantity of objects in the learning data.

Also, the object enumerating apparatus described above is further characterized in that the plurality of factor vectors corresponding to one object under detection, included in the factor matrix, are generated respectively from a plurality of learning data which differ in at, least one of a scale, a moving speed, and a moving direction of the object on a screen.

Another object enumerating apparatus of the present invention is mainly characterized by comprising binarized differential data generating means for generating and binarizing inter-frame differential data from moving image data comprised of a plurality of image frame data representative of a photographed object under detection, feature data extracting means for extracting feature data from three-dimensional data comprised of a plurality of the inter-frame binary differential data directly adjacent to each other through cubic higher-order local auto-correlation, learning means for generating a coefficient matrix for calculating the quantity of the object under detection based on feature data derived from a plurality of learning data which differ in at least one of a scale, a moving speed, and a moving direction of the object on a screen, quantity calculating means for calculating a quantity from a coefficient matrix previously generated by the learning means and the feature data derived from recognition data, and round-off means for rounding off an output value of the quantity calculating means to the decimal point to the closest integer.

An object enumerating method of the present invention is mainly characterized by comprising the steps of generating a factor matrix based on cubic higher-order local auto-correlation, based on learning data, generating and binarizing inter-frame differential data from moving image data comprised of a plurality of image frame data representative of a photographed object under detection, extracting feature data from three-dimensional data comprised of a plurality of the inter-frame binary differential data directly adjacent to each other through cubic higher-order local auto-correlation, calculating a coefficient of each factor vector from a factor matrix comprised of a plurality of factor vectors previously generated through learning and arranged for one object under detection, and the feature data, adding a plurality of the coefficients for one object under detection, and rounding off an output value of the adding means to the decimal point to the closest integer representative of a quantity.

### ADVANTAGES OF THE INVENTION

According to the present invention, effects are produced as follows.

(1) A plurality of factor vectors corresponding to objects which differ in scale or moving speed have been previously prepared through learning using a factor analysis and arranged to produce a factor matrix for a single object under detection. In the recognition, coefficients of each factor vector are added and rounded off to the closest integer to generate a quantity, thus resulting in small fluctuations in the sum of coefficients and accurate matching with the quantity of objects intended for recognition. It is therefore possible to accomplish the recognition robust to differences in scale, speed, direction of the object and to dynamic changes therein to improve the enumeration accuracy.

(2) Since a plurality of objects are simultaneously recognized without marking out the objects, a smaller amount of calculations is required for feature extraction and quantity recognition and determination. Also, the amount of calculations is constant irrespective of the quantity of objects. Consequently, real-time processing can be performed.

(3) A coefficient matrix can be previously generated through learning based on a multiple regression analysis using images of objects which differ in scale, moving speed, and direction, and the quantity can be directly calculated at high speeds. The quantity can be detected with robustness to the speed, direction, and scale.

### BRIEF DESCRIPTION OF THE DRAWINGS

FIG. 1 is a block diagram showing the configuration of an object enumerating apparatus according to the present invention.

FIG. 2 is an explanatory diagram showing an overview of an object enumerating process according to the present invention.

FIG. 3 is an explanatory diagram showing auto-correlation processing coordinates in a three dimensional voxel space.

FIG. 4 is an explanatory diagram showing an exemplary auto-correlation mask pattern.

FIG. 5 is an explanatory diagram showing details of moving image real-time processing according to the present invention.

FIG. 6 is an explanatory diagram showing an exemplary factor matrix which is generated in a learning mode.

FIG. 7 is a flow chart showing contents of an object enumerating process (learning mode) according to the present invention.

FIG. 8 is a flow chart showing contents of an object enumerating process (recognition mode) according to the present invention.

FIG. 9 is a flow chart showing contents of pixel CHLAC features extraction processing at S13.

### EXPLANATION OF THE REFERENCE NUMERALS

10 . . . Video Camera
11 . . . Computer
12 . . . Monitor Device
13 . . . Keyboard
14 . . . Mouse

### BEST MODE FOR CARRYING OUT THE INVENTION

While the following embodiments will be described in connection with an example in which an object is a person walking to the left or to the right, the present invention can be applied to objects which may include an arbitrary moving body or motional body which can be photographed as a moving image, and which may vary in any of shape, size, color, and brightness.

### Embodiment 1

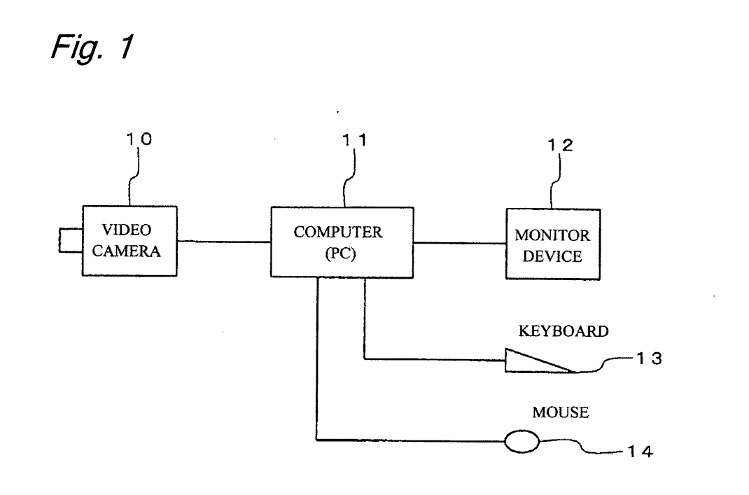

FIG. 1 is a block diagram showing the configuration of an object enumerating apparatus according to the present invention. A video camera 10 outputs moving image frame data of a target person, car or the like in real time. The video camera 10 may be a monochrome or a color camera. A computer 11 may be a known personal computer (PC) which is provided, for example, with a video capture circuit for capturing a moving image. The present invention is implemented by creating a processing program, later described, and installing the processing program into the known arbitrary computer 11 such as a personal computer, and starting the processing program.

A monitor device 12 is a known output device of the computer 11, and is used to display to the operator, for example, the quantity of detected objects. A keyboard 13 and a mouse 14 are known input devices used by the operator for inputting. In this regard, in this embodiment, moving image data input from the video camera 10, for example, may be processed in real time, or may be once saved in a moving image file and then sequentially read therefrom for processing. The video camera 10 may be connected to the computer 11 through an arbitrary communication network.

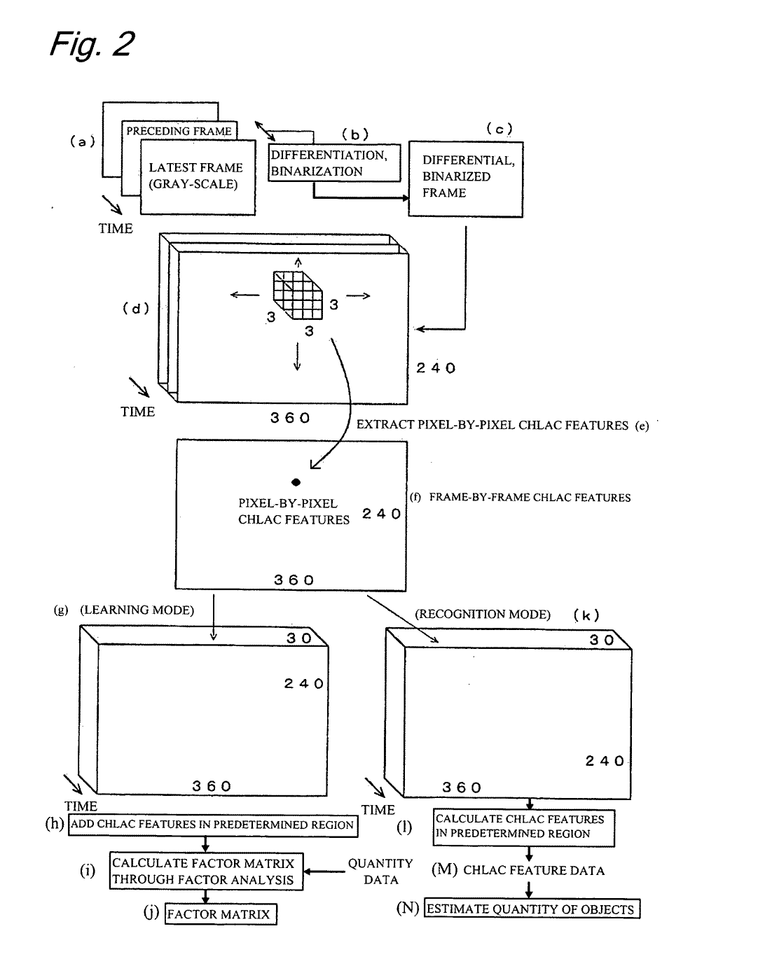

FIG. 2 is an explanatory diagram showing an overview of an object enumerating process according to the present invention. For example, the video camera 10 photographs a gray-scale (monochrome multi-value) moving image of 360 pixels by 240 pixels, which is sequentially captured into the computer 11.

An absolute value of the difference with a luminance value of the same pixel on the preceding frame is calculated from the captured frame data (a), and binary differential frame data (c) is generated. The binary differential frame data (c) takes one when the absolute value is equal to or larger than, for example, a predetermined, threshold, and otherwise takes zero. Next, CHLAC features are calculated on a pixel-by-pixel basis from the most recent three binary differential frame data (d) using a method later described. The pixel-by-pixel CHLAC features are added for one frame to generate frame-by-frame CHLAC features (f). The foregoing process is common to a learning mode and a recognition mode.

In the learning mode, a plurality of learning data associated CHLAC feature data are produced in association with a plurality of learning data by executing processing (h) for adding frame-by-frame CHLAC features (g) in a predetermined region (for example, for 30 frames in time width). Then, a factor matrix is produced by a factor analysis (i) using information on the quantity of each factor of known objects in the learning data. The factor matrix (j) enumerates a plurality of factor vector data, such as “a person walking to the right at a quick pace with a large scale,” “a person walking to the right at a normal pace with a small scale,” and the like, corresponding to one object, for example, “a person walking to the right.”

In the recognition mode, on the other hand, CHLAC feature data is produced (M) by executing processing (1) for adding frame-by-frame CHLAC features (k) for an immediately adjacent predetermined region (for example, for 30 frames in time width). Then, the quantity of the objects is estimated by a method later described using the factor matrix (j) previously generated in the learning mode (N).

In the quantity estimation processing (N), coefficients of individual factor vectors are found, and a plurality of factors associated with one object are added, and the resulting sum is rounded off to the number of decimal places to calculate the quantity. This processing enables a recognition which is robust to a difference in scale and speed of the object as well as to dynamic changes thereof.

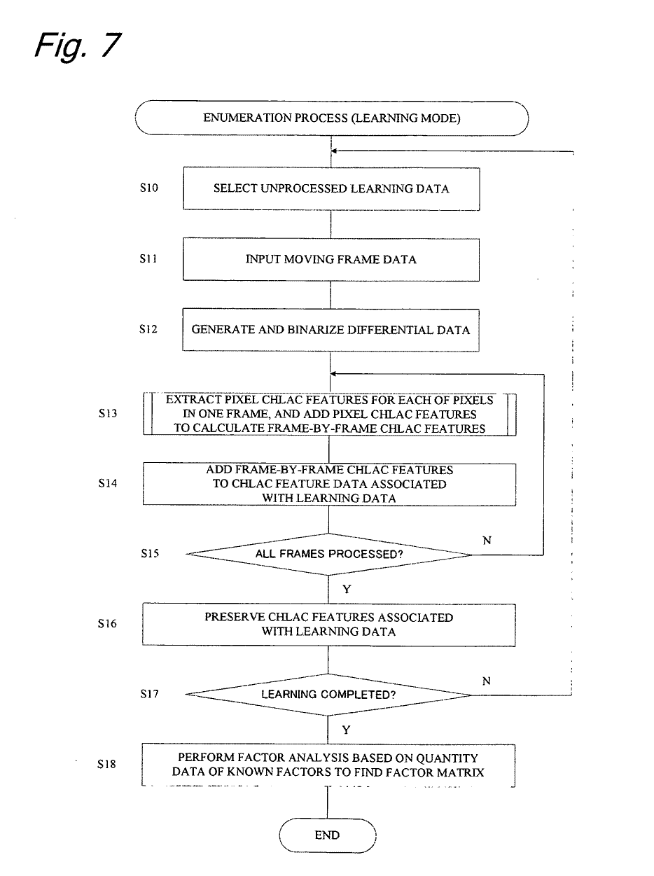

In the following, details of the processing will be described. FIG. 7 is a flow chart showing contents of an object enumerating process (learning mode) according to the present invention. At S10, unprocessed learning data is selected. Learning data refers to moving image data which represents arbitrary numbers of two types of objects, for example, “a person walking to the right” and “a person walking to the left” which are photographed at different moving speeds (at a normal pace or a quick pace or at a run) and at different scales (larger (nearer), middle, smaller (further)). The two types of objects may co-exist in arbitrary quantities. In this regard, the quantity, moving speed, and scale of each object are known in the learning data. At this time, the learning data associated CHLAC features is cleared.

At S11, frame data is entered (read into a memory).

In this event, image data is, for example, gray scale data at 256 levels of gradation. At S12, information on “motion” is detected for the moving image data, and differential data is generated for purposes of removing stationary regions such as background.

The difference is taken with the employment of an inter-frame differential scheme for extracting a change in luminance of pixels at the same position between adjacent frames. Alternatively, an edge differential scheme may be employed for extracting a portion within a frame in which the luminance has changed, or both schemes may be employed. In this regard, when each pixel has RGB color data, the distance between two RGB color vectors may be calculated as differential data between two pixels.

Further, binarization is performed through automatic threshold selection for removing color information and noise which are irrelevant to “motions.” Methods employed for the binarization may include, for example, a fixed threshold, a discriminant minimum square automatic thresholding method disclosed in the following Non-patent Document 1, zero-threshold and noise processing scheme (noise is removed by a known noise removing method in a contrast image, where every part has a movement (=1) unless the difference is zero), and the like.

Since the discriminant minimum square automatic thresholding method detects noise in a scene in which objects do not at all exist, a lower limit value is set to a threshold for a luminance differential value to be binarized when the threshold is smaller than a predetermined lower limit value. With the foregoing preprocessing, input moving data is transformed into a sequence of frame data (c), each of which has a logical value “1” (with motion) or “0” (without motion) for a pixel value.

Non-Patent Document 1 “Automatic Threshold Selection Based on Discriminant and Least-Squares Criteria,” Transactions D of the Institute of Electronics, Information and Communication Engineers, J63-D-4, pp. 349-356, 1980.

At S13, pixel CHLAC features, which are 251-dimension feature data, is extracted for each of pixels in one frame, and the pixel CHLAC features of one frame are added to generate frame-by-frame CHLAC features.

Here, a description will be given of cubic higher-order local auto-correlation (CHLAC) features. An N-th auto-correlation function can be represented as shown by the following Equation 1:

x_{N}(a₁, . . . , a_{N})=∫f(r)f(r+a₁) . . . f(r+a_{N})dr [Equation 1]

where f is a pixel value (differential value), and a reference point (target pixel) r and N displacements aᵢ (i=1, . . . , N) viewed from the reference point are three-dimensional vectors which also have two-dimensional coordinates and time within a binary differential frame as components.

While the higher-order auto-correlation function can be thought in unmeasured numbers depending to how to determine a displacement direction and the number of order, a higher-order local auto-correlation function limits this to a local region. In cubic higher-order local auto-correlation features, the displacement direction is limited to a local area occupied by 3×3×3 pixels centered at the reference point r, i.e., to 26 neighbors of the reference point r. The integrated value of Equation 1 corresponding to one set of displacement directions constitutes one element of the feature amount. Accordingly, elements of feature amounts are produced as many as the number of combinations of displacement directions (=mask patterns).

The number of elements of the feature amount, i.e., the order of a feature vector is comparable to the type of mask pattern. With a binary image, one is derived by multiplying the pixel value “1” whichever number of times, so that terms of second and higher powers are deleted on the assumption that they are regarded as duplicates of a first-power term only with different multipliers. Also, in regard to the duplicated patterns resulting from the integration of Equation 1 (translation: scan), a representative one is maintained, while the rest is deleted. The right side of Equation 1 necessarily contains the reference point (f(r): the center of the local area), so that a representative pattern to be selected should include the center point and be exactly fitted in the local area of 3×3×3 pixels.

As a result, there are a total of 352 types of mask patterns which include the center points, i.e., mask patterns with one selected pixel: one, mask patterns with two selected pixels: 26, and mask patterns with three selected pixels: 26×25/2=325. However, with the exclusion of duplicated mask patterns resulting from the integration in Equation 1 (translation: scanning), there are 251 types of mask patterns. In other words, there is a 251-dimensional cubic higher-order local auto-correlation feature vector for one three-dimensional data.

In this regard, when a contrast image is made up of multi-value pixels, for example, where a pixel value is represented by “a,” a correlation value is a (zero-th order) a×a (first order) a×a×a (second order), so that duplicated patterns with different multipliers cannot be deleted even if they have the same selected pixels. Accordingly, when a multivalue case is concerned, two mask patterns are added to those associated with the binary image when one pixel is selected, and 26 mask patterns are added when two pixels are selected, so that there are a total of 279 types of mask patterns.

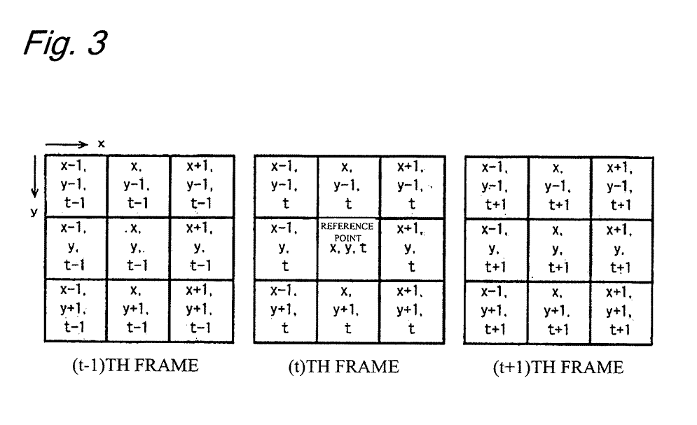

FIG. 3 is an explanatory diagram showing auto-correlation processing coordinates in a three dimensional voxel space. FIG. 3 shows xy-planes of three differential frames, i.e., (t−1) frame, t frame, (t+1) frame side by side. The present invention correlates pixels within a cube composed of 3×3×3 (=27) pixels centered at a target reference pixel. A mask pattern is information indicative of a combination of the pixels which are correlated. Data on pixels selected by the mask pattern is used to calculate a correlation value, whereas pixels not selected by the mask pattern is neglected. As mentioned above, the target pixel (center pixel: reference point) is selected by the mask pattern without fail.

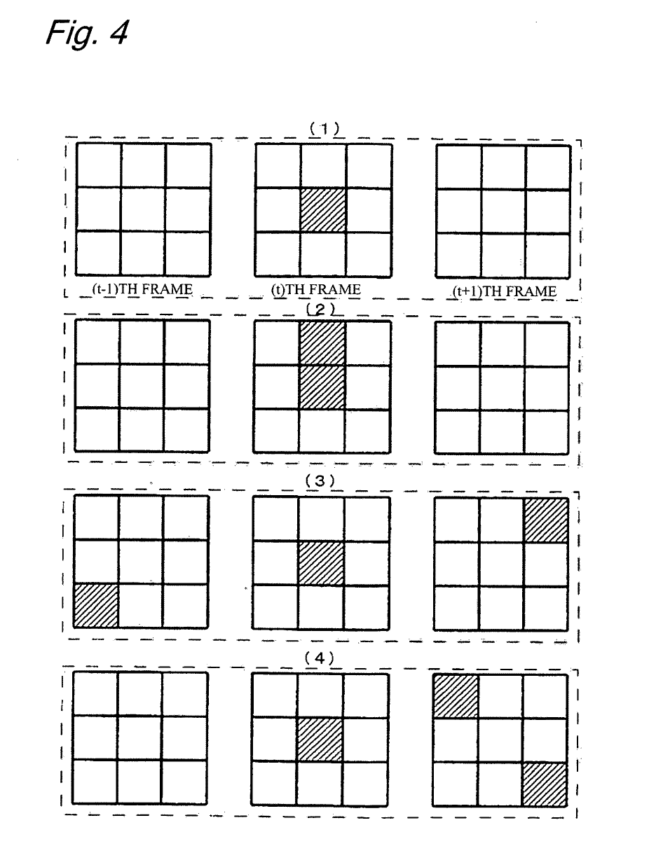

FIG. 4 is an explanatory diagram showing examples of auto-correlation mask patterns. FIG. 4(1) is the simplest zero-th order mask pattern which comprises only a target pixel. (2) is an exemplary first-order mask pattern for selecting two hatched pixels. (3), (4) are exemplary third-order mask patterns for selecting three hatched pixels. Other than those, there are a multiplicity of patterns. Then, as mentioned above, there are 251 types of mask patterns when duplicated patterns are omitted. Specifically, there is a 251-dimensional cubic higher-order local auto-correlation feature vector for three-dimensional data of 3×3×3 pixels, where elements have the value of “0” or “1.”

Turning back to FIG. 7, at S14, the frame-by-frame CHLAC features are added to learning data associated CHLAC features on an element-by-element basis. At S15, it is determined whether or not all frames of the learning data have been processed, and the process goes to S13 when the determination result is negative, whereas the process goes to S16 when affirmative. At S16, the learning data associated CHLAC features is preserved. At S17, it is determined whether or not all the learning data have been completely processed, and the process goes to S10 when the determination result is negative, whereas the process goes to S18 when affirmative.

At S18, a factor analysis is performed on the basis of data on the quantity of known factors to find a factor matrix. Here, the factor analysis will be described. First, in the embodiment, a factor refers to a type of an object which is identified by shape, scale, moving speed or the like. In the embodiment, for example, “a large-scale person walking to the right at a normal pace” is one factor within one object which is “a person walking to the right,” and a different factor will result even from the same object if the speed or scale is different.

Then, a cubic higher-order local auto-correlation feature vector extracted from learning data which includes only one factor existing on a screen, for example, is equivalent to a factor vector. In other words, a factor vector refers to a feature vector inherent to an individual factor.

Assuming herein that a moving image as cubic data is composed of a combination of m factor vector fⱼ (0=j=m−1), a cubic higher-order local auto-correlation feature z derived from this cubic data is represented in the following manner by a linear combination of fⱼ due to its additivity and position invariance:

when F=[f₀, f₁, . . . fₘ₋₁]^{T}, a=[a₀, a₁, . . . , aₘ₋₁]^{T}, z=a₀f₀+a₁f₁+ . . . +aₘ₋₁fₘ₋₁+e=F^{T}a+e [Equation 2]

Here, define that F is a factor matrix, a coefficient aⱼ, when represented by a linear combination, is a factor added amount, and the coefficients aⱼ are arranged for vectorization into a factor added amount vector a. Also, e represents an error. The factor added amount represents the quantity of objects corresponding to factors. For example, when f₀ is a factor representative of a person walking to the right, a₀=2 indicates that there are two persons who are walking to the right in a moving image. Accordingly, when the factor added amount vector can be derived, one can know which object exists within a screen in which quantity. For this reason, a factor matrix is previously acquired by learning, and a factor added amount vector is found using the factor matrix during recognition.

In the learning mode, the factor matrix F=[f₀; f₁; . . . ; fₘ₋₁]^{T} is found. Given as a teacher signal is a factor added amount vector a which represents a quantity corresponding to each factor. In the following, a specific learning process will be described. Assume that N is the number of moving image data used as learning data; zᵢ is a cubic higher-order local auto-correlation feature corresponding to i-th learning data (1=i=N); and aᵢ=[aᵢ₀; aᵢ₁; . . . ; aᵢ₍ₘ₋₁₎] is a factor added amount vector. In this event, the factor matrix F can be positively found by minimizing the error e in the following Equation 3:

when aᵢ=[aᵢ₀, aᵢ₁, . . . , aᵢ₍ₘ₋₁₎]^{T}, zᵢ=aᵢ₀f₀+aᵢ₁f₁+ . . . +aᵢ₍ₘ₋₁₎fₘ₋₁+eᵢ=F^{T}aᵢ+eᵢ [Equation 3]

A mean square error of Equation 3 is as follows:

$$\begin{matrix}when E is substituted for an average manipulation \text{:} \\ & \\ \frac{1}{N} {\sum }_{i = 1}^{N} , \\ \begin{matrix} {ɛ}^{2} [ F ] = {E}_{i} {‖ {F}^{T} {a}_{i} - {z}_{i} ‖}^{2} \\ = {E}_{i} \{ {a}_{i}^{T} {FF}^{T} {a}_{i} - 2 {a}_{i}^{T} {Fz}_{i} + {z}_{i}^{T} {z}_{i} \} \\ = tr ( {F}^{T} ( {E}_{i} [ {a}_{i} {a}_{i}^{T} ] F ) ) - \\ 2 tr ( {F}^{T} ( {E}_{i} [ {a}_{i} {z}_{i}^{T} ] ) ) + {E}_{i} ( {z}_{i}^{T} {z}_{i} ) \\ = tr ( {F}^{T} {R}_{aa} F ) - 2 tr ( {F}^{T} {R}_{az} ) + {E}_{i} [ {z}_{i}^{T} {z}_{i} ]\end{matrix} & [ Equation 4 ] \\ where & \\ {R}_{aa} = {E}_{i} ⌊ {a}_{i} {a}_{i}^{T} ⌋ , {R}_{az} = {E}_{i} ⌊ {a}_{i} {z}_{i}^{T} ⌋ & \end{matrix}$$

Rₐₐ and R_{az} are an auto-correlation matrix of aᵢ and a cross-correlation matrix of aᵢ and zᵢ. In this event, F which minimizes the error e is derived by solving the following Equation 5, and the solution can be positively derived within a range of linear algebra as shown in Equation 6.

$$\begin{matrix}\begin{matrix}\frac{\partial {ɛ}^{2} [ F ]}{\partial F} = 2 {R}_{aa} F - 2 {R}_{az} \\ = 0\end{matrix} & [ Equation 5 ] \\ F = {R}_{aa}^{- 1} {R}_{az} & [ Equation 6 ]\end{matrix}$$

This learning method has the following three advantages.

(1) Each object need not be marked out for indication.

(2) Factors required for recognition are automatically and adaptively acquired by simply indicating the quantity of objects which exist within a screen.

(3) Since the solution can be positively derived in a range of linear algebra, no need exists for considering the convergence of the solution or the convergence of a local solution, with a less amount of calculations.

FIG. 6 is an explanatory diagram showing an exemplary factor matrix generated by the learning mode. This example shows a factor matrix which includes two types, a “person walking to the right” and a “person walking to the left” as objects. The “person walking to the right” is associated with nine factor vectors f₀-f₁₆ (suffixes are even numbers) which differ in moving speed (at running, quick, and normal paces) and scale (large, middle, small), and the “person walking to the left” is also associated with nine factor vectors f₁-f₁₇ (suffixes are odd numbers). An image shown in FIG. 6 is an exemplary differential binary image of learning data corresponding to an individual factor vector.

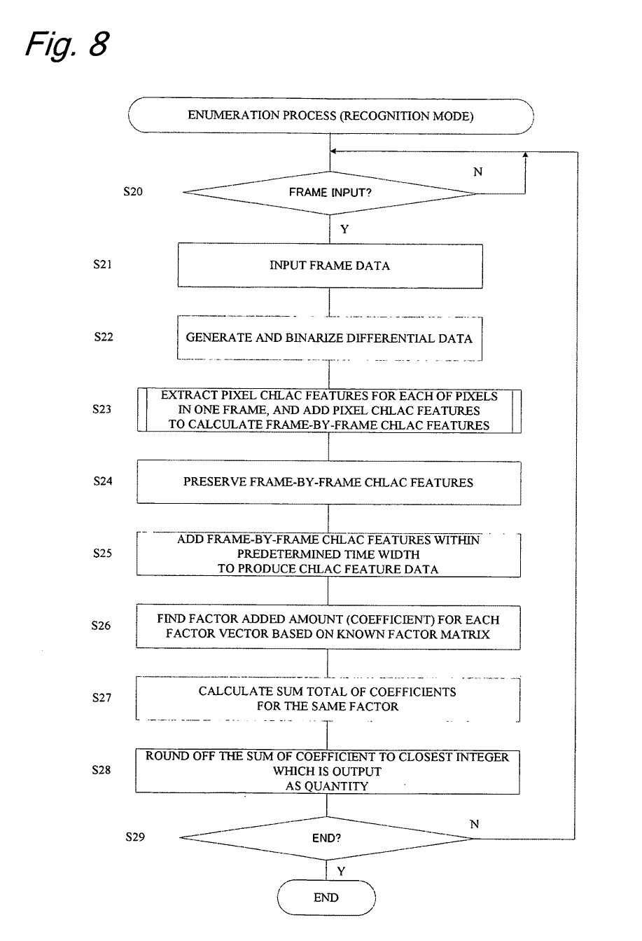

FIG. 8 is a flow chart showing the contents of an object enumerating process (recognition mode) according to the present invention. At S20, the process waits until frames are input, and at S21, frame data is input. At S22, differential data is generated as previously described for binarization. At S23, pixel CHLAC features are extracted for each of pixels in one frame, and the pixel CHLAC features for one frame are added to produce frame-by-frame CHLAC feature data. The processing at S21-S23 are the same as that at S11-S13 in the aforementioned learning mode. At S24, the frame-by-frame CHLAC features are preserved. At S25, the frame-by-frame CHLAC features within the closest predetermined time width are added to produce CHLAC feature data.

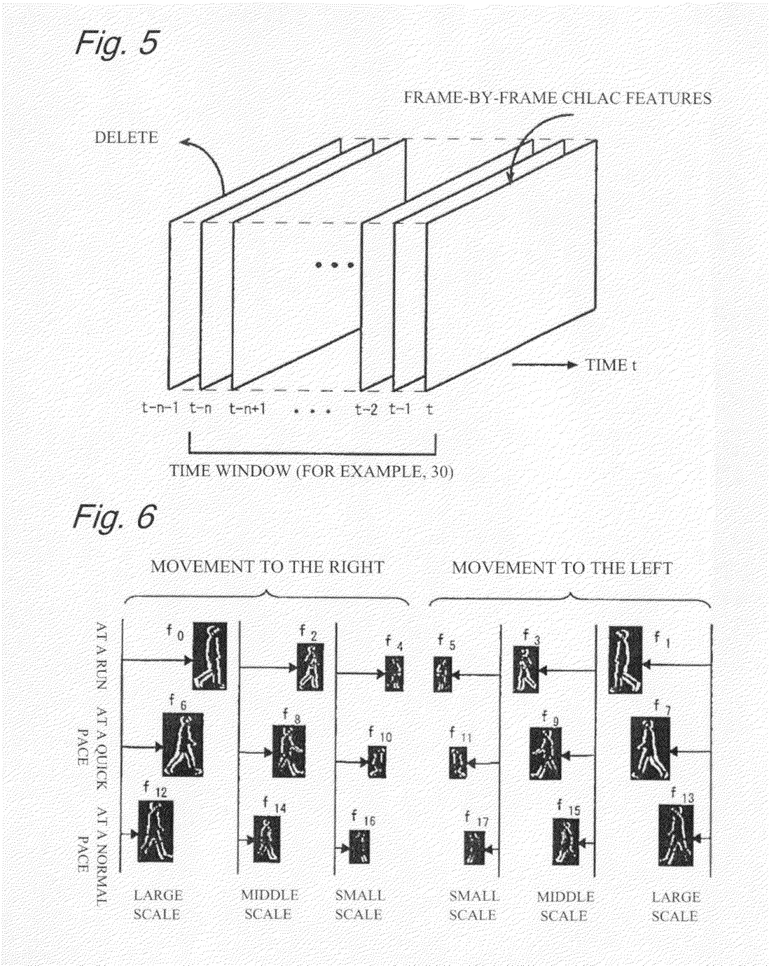

FIG. 5 is an explanatory diagram showing the contents of a moving image real-time process according to the present invention. CHLAC feature data derived at S24 is in the form of a sequence of frames. As such, a time window having a constant width is set in the time direction, and a set of frames within the window is designated as one three-dimensional data. Then, each time a new frame is entered, the time window is moved, and an obsolete frame is deleted to produce finite three-dimensional data. The length of the time window is preferably set to be equal to or longer than one period of an action which is to be recognized.

Actually, only one frame of the image frame data is preserved for taking a difference, and the frame-by-frame CHLAC features corresponding to the frames are preserved only for the time window. Specifically, at the time a new frame is entered at time t, frame-by-frame CHLAC features corresponding to the preceding time windows (t−1, t−n−1) have been already calculated. Notably, three immediately adjacent differential frames are required for calculating frame CHLAC features, but since a (t−1) frame is located at the end, the frame CHLAC features are calculated up to that corresponding to a (t−2) frame.

Thus, frame-by-frame CHLAC features corresponding to the (t−1) frame are generated using t newly entered frames and added to the CHLAC feature data. Also, frame-by-frame CHLAC features corresponding to the most obsolete (t−n−1) frame are subtracted from the CHLAC feature data. CHLAC feature data corresponding to the time window is updated through such processing.

Turning back to FIG. 8, at S26, a factor added amount (coefficient) a is found for each factor vector based on a known factor matrix derived through learning. When there is a cubic higher-order local auto-correlation feature z derived from a moving image which one wishes to recognize, z should be represented as a linear combination of the factor vectors f derived through learning, as shown in Equation 3. As such, in this event, a factor added amount vector a is found such that it has a coefficient which minimizes the error e.

The following description will be made on a specific process for finding the factor added amount a which minimizes the error e in Equation 3. A minimum square error is represented by the following Equation 7:

$$\begin{matrix}{ɛ}^{2} [ \hat{a} ] = {‖ {F}^{T} \hat{a} - z ‖}^{2} \\ = {\hat{a}}^{T} {FF}^{T} \hat{a} - 2 \hat{a} Fz + {z}^{T}\end{matrix} \qquad [ Equation 7 ]$$

A coefficient a which minimizes this can be positively derived by solving the following Equation 8, as shown in Equation 9.

$$\begin{matrix}\begin{matrix}\frac{\partial {ɛ}^{2} [ \hat{a} ]}{\partial F} = 2 {FF}^{T} \hat{a} - 2 {F}_{z} \\ = 0\end{matrix} & [ Equation 8 ] \\ \hat{a} = {( {FF}^{T} )}^{- 1} Fz & [ Equation 9 ]\end{matrix}$$

The factor added amount a thus derived is not an integer but a real value including the number to the right of the decimal point. At S27, the sum total of coefficients of a plurality of factors belonging to the same object is calculated. Specifically, the sum total is calculated, for example, for coefficients of nine factors (f₀, f₂, f₄ . . . f₁₆) belonging to the “person moving to the right” shown in FIG. 6.

At step 28, the sum total of the coefficients is rounded off to the decimal point to derive an integer which is output as the quantity for each object. At S29, it is determined whether or not the process is terminated, and the process goes to S20 when the determination result is negative, while the process is terminated when affirmative.

In the conventional CHLAC features based quantity recognition, a factor added amount which is a coefficient of each factor is simply rounded off to the nearest integer which is regarded as the result of quantity recognition. However, in such a way, the quantity is not successfully recognized when factors exist with different scales and speeds. As a result of a variety of experiments made by the present inventors, it has been revealed that the recognition can be made robust to differences in scale and speed by using a strategy which involves providing one object with factors separately depending on differences in scale and walking pace within a screen, summing up factor added amounts of factors belonging to the same object, and then rounding off the sum to the nearest integer.

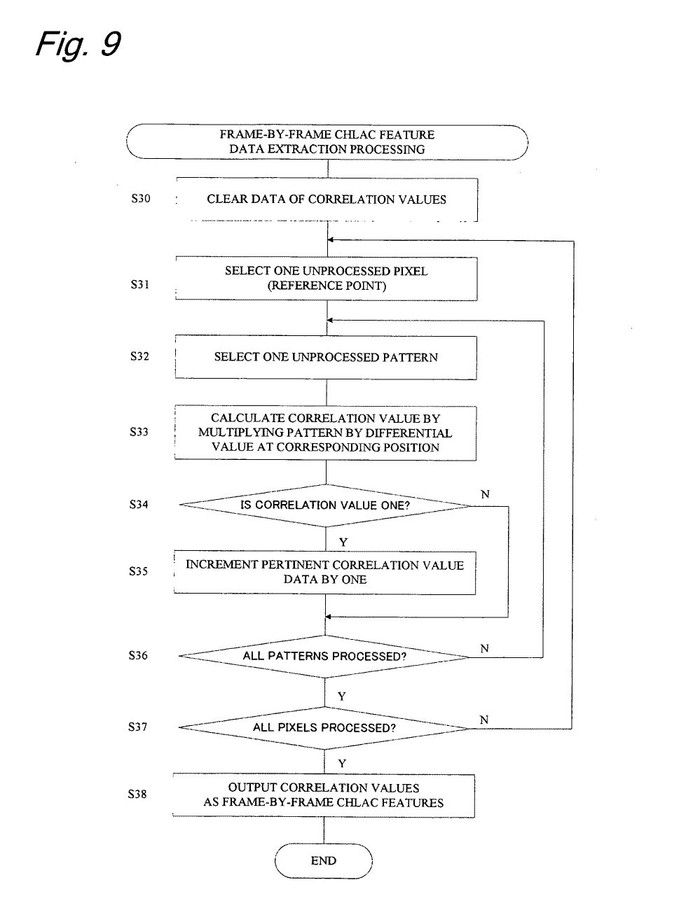

FIG. 9 is a flow chart showing the contents of the pixel CHLAC features extraction processing at S13. At S30, data of correlation values corresponding to 251 correlation patterns are cleared. At S31, one of unprocessed target pixels (reference points) is selected (by scanning the target pixels or reference points in order within a frame). At S32, one of unprocessed correlation mask patterns is selected.

At S33, the correlation value is calculated using the aforementioned Equation 1 by multiplying a pattern by a differential value (0 or 1) at a corresponding position. This processing is comparable to the calculation of f(r)f(r+a1) . . . f(r+aN) in Equation 1.

At S34, it is determined whether or not the correlation value is one. The process goes to S35 when the determination result is affirmative, whereas the process goes to S36 when negative. At S35, the correlation value data corresponding to the mask pattern is incremented by one. At S36, it is determined whether or not all mask patterns have been processed. The process goes to S37 when the determination result is affirmative, whereas the process goes to S32 when negative.

At S37, it is determined whether or not all pixels have been processed. The process goes to S38 when the determination result is affirmative, whereas the process goes to S31 when negative. At S38, a set of added correlation value data of one frame is output as frame-by-frame CHLAC features.

### Embodiment 2

In the factor analysis of Embodiment 1, inherent factor vectors are derived for the type, motion, scale and the like of each moving object during the learning phase, and the quantity of objects is derived in the form of the sum of coefficients of each factor vector in the recognition phase, in order to provide desired measurement results. In this event, factors are provided in accordance with differences in scale and speed, and their coefficients are added and thereafter rounded off to the closest integer, thereby allowing for recognition robust to changes of the objects in scale and speed. This approach is useful for approaches using them, for example, in measuring a traffic density and detecting abnormalities because a feature vector is derived in correspondence to each factor.

However, the result of an experiment has revealed that when one wishes to simply know only the quantity, the quantity can be measured at high speeds and in a robust manner by use of a multiple regression analysis which is a more direct approach than the factor analysis.

For accomplishing a robust recognition to scale and speed using a multiple regression analysis, learning is performed using learning data which includes objects with a variety of scales and speeds, in a manner similar to the factor analysis. However, a different concept from the factor analysis is applied to a teacher signal for the learning data.

The factor analysis involves using a teacher signal including differences in scale and speed as well, and summing up coefficients of detected objects during recognition, whereas the multiple regression analysis uses the sum previously at the stage of teacher signal. In other words, the multiple regression analysis uses a teacher signal which neglects differences in scale and speed.

For example, when there are data which include large, middle, and small scales as a “person walking to the right,” the factor analysis divides them and gives a teacher signal such as one “large-scale person walking to the right.” On the other hand, the multiple regression analysis simply gives the quantity of “persons walking to the right,” neglecting such differences in scale and speed. The number of persons can be measured in a manner robust to the difference in scale and speed without the need for performing additions during the recognition. In the following, specific contents will be described.

The multiple regression analysis used in Embodiment 2 refers to an approach for determining a coefficient matrix B which minimize a least square error of an output yᵢ=B^{T}zᵢ and aᵢ, where aᵢ is a desired measurement result when a certain feature amount zᵢ is derived. In this event, an optimal coefficient matrix is uniquely found, and a system can calculate a measured value (quantity) for a new input feature vector at high speeds by using the found appropriate coefficient matrix B. A detailed calculation method will be described below.

<<Leaning Phase>>

Assume that N is the number of cubic data used as learning data, i.e., the number of learning data; zᵢ is a cubic higher-order local auto-correlation feature for an i-th (1=i=N) cubic data; and aᵢ=[aᵢ₀, aᵢ₁, . . . , aᵢ₍ₘ₋₁₎]^{T} is a teacher signal. Assume that the teacher signal neglects differences in scale and speed and is represented by a=(the number of persons walking to the right, the number of persons walking to the left)T even if learning data includes “persons walking to the right” and “persons walking to the left” who largely vary in scale and speed. A mean square error of the teacher signal aᵢ with an output yᵢ=B^{T}zᵢ is calculated as follows:

$$\begin{matrix}when E is substituted for an average manipulation \text{:} & \\ \frac{1}{N} {\sum }_{i = 1}^{N} , \\ \begin{matrix} {ɛ}^{2} [ B ] = {E}_{i} {‖ {B}^{T} {z}_{i} - {a}_{i} ‖}^{2} \\ = {E}_{i} \{ {z}_{i}^{T} {BB}^{T} {z}_{i} - 2 {z}_{i}^{T} {Ba}_{i} + {a}_{i}^{T} {a}_{i} \} \\ = tr ( {B}^{T} ( {E}_{i} [ {z}_{i} {z}_{i}^{T} ] B ) ) - \\ 2 tr ( {B}^{T} ( {E}_{i} [ {z}_{i} {a}_{i}^{T} ] ) ) + {E}_{i} ( {a}_{i}^{T} {a}_{i} ) \\ = tr ( {B}^{T} {R}_{zz} B ) - 2 tr ( {B}^{T} {R}_{za} ) + {E}_{i} [ {a}_{i}^{T} {a}_{i} ]\end{matrix} & [ Equation 10 ] \\ where & \\ {R}_{zz} ≡ {E}_{i} ⌊ {z}_{i} {z}_{i}^{T} ⌋ {R}_{za} = {E}_{i} ⌊ {z}_{i} {a}_{i}^{T} ⌋ & \end{matrix}$$

R_{zz} and R_{za} are an auto-correlation matrix of zᵢ and a cross-correlation matrix of zᵢ and aᵢ. In this event, B which minimizes the mean square error e is derived by solving the following Equation 11, and the solution can be positively derived within a range of linear algebra as shown in Equation 12.

$$\begin{matrix}\begin{matrix}\frac{\partial {ɛ}^{2} [ B ]}{\partial B} = 2 {R}_{zz} B - 2 {R}_{za} \\ = 0\end{matrix} & [ Equation 11 ] \\ B = {R}_{zz}^{- 1} {R}_{za} & [ Equation 12 ]\end{matrix}$$

<<Recognition Phase>>

In the recognition, the coefficient matrix B derived in the learning phase can be multiplied by a derived feature vector in the following manner, to directly calculate the quantity of objects.

â=B^{T}z [Equation 13]

When the multiple regression analysis is used, each factor vector is not directly derived, thus failing to detect abnormalities, using the distance to a partial space defined by each factor vector, provide additional information required for measuring a traffic density, and the like. It is therefore necessary to strategically use the approaches of Embodiment 1 and Embodiment 2 depending on a particular object or situation. Additionally, the two approaches can be used in combination to improve both the processing speed and recognition accuracy.

While some embodiments have been described, the present invention can be applied, for example, to a traffic density measurement system for measuring the number of cars and persons who pass across a screen. While the system of the embodiments outputs the quantity of objects within the screen in real time, the system of the embodiments cannot directly present the number of objects which have passed, for example, per hour. Thus, the quantity of objects which have passed per unit time can be calculated by integrating quantity information output by the system of the present invention over time, and dividing the resulting integrated value by an average time taken by the objects which passed across the screen, derived from an average moving speed of the objects or the like. The average time taken by the objects to pass across the screen can also be estimated from fluctuations in the quantity information output from the system of the invention.

Also, an exemplary modification can be contemplated for the present invention as follows. The embodiments have disclosed an example of entirely generating a plurality of factor vectors which differ in scale, moving speed and the like for a single object from learning data through a factor analysis. Alternatively, a factor vector may be calculated from other factor vectors through interpolation or extrapolation, such as generating a factor vector corresponding to a middle scale from a factor vector corresponding to a large scale and a factor vector corresponding to a small scale through calculations.

While the embodiments have disclosed an example of using a variety of learning data for the scale and speed of a target image, the quantity of objects can be measured in a manner robust to moving directions of objects, just like to the scale and speed. For example, as an exemplary application of a robust quantity measurement using the factor analysis, persons walking in various directions can be photographed from above to measure the total number of persons moving in an arbitrary direction.

Eight directions are employed for factors of directions in which persons walk, for example, upward, downward, to the left and right, diagonally to upper (lower) right, and diagonally to upper (lower) left. Then, factors of the eight directions are learned. In the recognition, each factor added amount is calculated using the learned factor matrix, these factor added amounts are added in a manner similar to the case of scale and speed, and the resulting sum is rounded off to the closest integer to present the number of pedestrians. In this regard, the prepared directions can be increased or decreased in accordance with a particular application. Also, when the multiple regression analysis is used, the number of pedestrians may be simply designated as a teacher signal, neglecting the directivity.

With the foregoing method, the quantity can be measured in a robust manner even for those objects which move about in various directions. Contemplated as practical applications include measurement of quantity of pedestrians or vehicles using a camera which photographs a (scramble) intersection and the like from above, measurement of quantity of moving living creature or particles, particularly, measurement of quantity of micro-organism, particles and the like, particularly using a microscope or the like, a comparison of quantities between stationary objects and moving objects, analysis on tendency of movements, and the like.

1. An object enumerating apparatus characterized by comprising:
binarized differential data generating means for generating and binarizing inter-frame differential data from moving image data comprised of a plurality of image frame data representative of a photographed object under detection;
feature data extracting means for extracting feature data from three-dimensional data comprised of a plurality of the inter-frame binary differential data directly adjacent to each other through cubic higher-order local auto-correlation;
coefficient calculating means for calculating a coefficient of each factor vector from a factor matrix comprised of a plurality of factor vectors previously generated through learning and arranged for one object under detection, and the feature data;
adding means for adding a plurality of the coefficients for one object under detection; and
round-off means for rounding off an output value of said adding means to the decimal point to the closest integer representative of a quantity.

2. An object enumerating apparatus according to claim 1, characterized by further comprising learning means for generating a factor matrix based on feature data derived from learning data.

3. An object enumerating apparatus according to claim 2, characterized in that said learning means comprises:
binarized differential data generating means for generating and binarizing inter-frame differential data from moving image data comprised of a plurality of image frame data representative of a photographed object under detection which comprises learning data;
feature data extracting means for extracting feature data from three-dimensional data comprised of a plurality of the inter-frame binarized differential data through cubic higher-order local auto-correlation; and
factor matrix generating means for generating a factor matrix from the feature data corresponding to a plurality of learning data through a factor analysis using a known quantity of objects in the learning data.

4. An object enumerating apparatus according to claim 2, characterized in that said plurality of factor vectors corresponding to one object under detection, included in the factor matrix, are generated respectively from a plurality of learning data which differ in at least one of a scale, a moving speed, and a moving direction of the object on a screen.

5. An object enumerating apparatus characterized by comprising:
binarized differential data generating means for generating and binarizing inter-frame differential data from moving image data comprised of a plurality of image frame data representative of a photographed object under detection;
feature data extracting means for extracting feature data from three-dimensional data comprised of a plurality of the inter-frame binary differential data directly adjacent to each other through cubic higher-order local auto-correlation;
learning means for generating a coefficient matrix for calculating the quantity of the object under detection based on feature data derived from a plurality of learning data which differ in at least one of a scale, a moving speed, and a moving direction of the object on a screen;
quantity calculating means for calculating a quantity from a coefficient matrix previously generated by said learning means and the feature data derived from recognition data; and
round-off means for rounding off an output value of said quantity calculating means to the decimal point to the closest integer.

6. An object enumerating method characterized by comprising the steps of:
generating a factor matrix based on cubic higher-order local auto-correlation, based on learning data;
generating and binarizing inter-frame differential data from moving image data comprised of a plurality of image frame data representative of a photographed object under detection;
extracting feature data from three-dimensional data comprised of a plurality of the inter-frame binary differential data directly adjacent to each other through cubic higher-order local auto-correlation;
calculating a coefficient of each factor vector from a factor matrix comprised of a plurality of factor vectors previously generated through learning and arranged for one object under detection, and the feature data;
adding a plurality of the coefficients for one object under detection; and
rounding off an output value of said adding means to the decimal point to the closest integer representative of a quantity.
